(19) United States
(12) Patent Application Publication
(10) Pub. No.: US 2002/0096398 A1
(43) Pub. Date: Jul. 25, 2002

(54) Top rails for scaffold ladders

(76) Inventor: Yates Westley Hayman, Walker, LA (US)

Correspondence Address: BERNARD F. MERONEY ---------JONES,, WALKER, WAECHTER,POITEVENT,CARRER&DENEGRE,L.L.P., 5TH FLOOR,FOUR UNITED PLAZA BOULEVARD, 8555 UNITED PLAZA BOULEVARD, BATON ROUGE, LA, 70809, US

(21) Appl. No.: 09/767,569

(22) Filed: Jan. 22, 2001

(51) Int. Cl. E06C 1/36

(52) U.S. Cl. 182/206; 182/178.1

(57) ABSTRACT

Top rails of a ladder, where the top rails include a left and right top rail, each attachable to or forming part of the left and right hand rails respectively of the ladder. The two top rails are designed to diverge, creating room for a climber to easily pass between the two top rails. Each top rail is attachable to either a scaffold horizontal or vertical member through an attachment member positioned at or near the end of each top rail.

### FIELD OF INVENTION

This invention relates to scaffold structures and, in particular, to top rails for scaffold ladders.

### BACKGROUND OF THE INVENTION

Devices for accessing or mounting a scaffold platform generally consist of ladders, either added on to the structure of the scaffold structure or climbing the structure of the scaffold itself. It is difficult for a climber to easily and safely exit the ladder onto a scaffold deck, as the ladders typically require the climber to swing around the ladder at the point of exit.

### OBJECTS OF THE INVENTION

It is an object of the invention to provide top rails for a scaffold ladder that allows a climber to easily and safely exit the ladder.

It is an object of the invention to provide top rails for a scaffold ladder that can be easily attached to existing ladders.

### SUMMARY OF THE INVENTION

The invention is top rails of a scaffold ladder, where the top rails are a left and right top rail, each attachable to or forming part of the left and right hand rails respectively of the ladder. The two top rails are designed to diverge, creating room for a climber to easily pass between the two top rails. Each top rail is attachable to either a scaffold horizontal or vertical member through an attachment member positioned at or near the end of each top rail.

### BRIEF DESCRIPTION OF THE DRAWINGS

FIG. 1 depicts a side view of a scaffold structure with a scaffold ladder having the top rails attached.

FIG. 2A is a detailed front view of one embodiment of a top rail.

FIG. 2B is detailed side view of one embodiment of a top rail.

FIG. 3 is a prospective of a top rail showing an alternative attachment member.

### DETAILED DESCRIPTION OF THE INVENTION

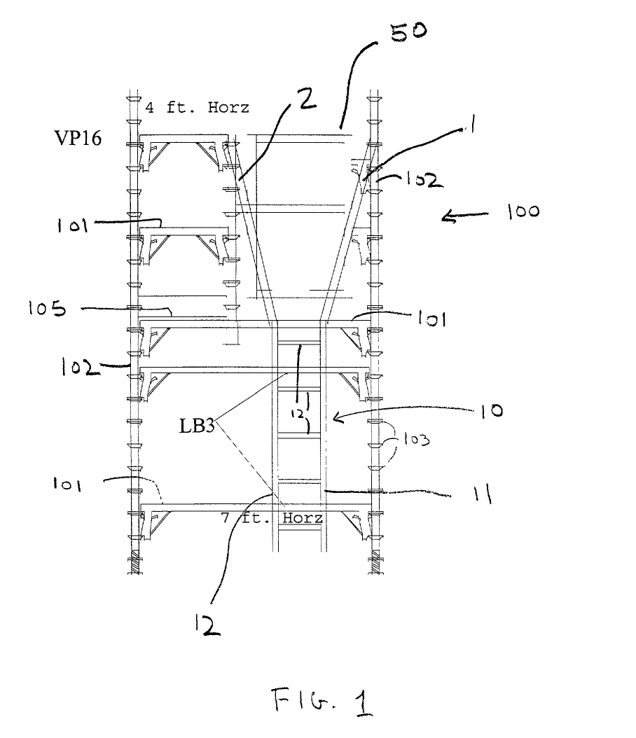

The invention is top rails for scaffold ladders. Shown in FIG. 1 is a scaffold structure 100, having horizontal 101 and vertical members 102 (collectively, scaffold members). Shown on the vertical members are rings or cups 103, designed as attachment points for the horizontal and vertical members. Also shown is a scaffold platform 105.

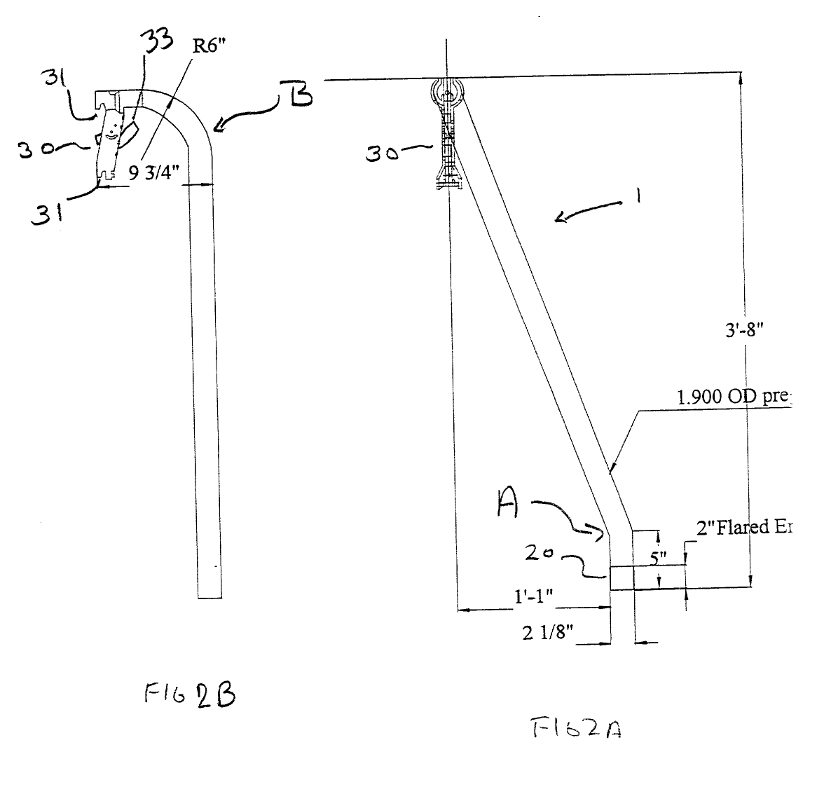

Connected to the scaffold structure 100 is a scaffold ladder 10, having right 11 and left 12 hand rails, and a series of rungs 12 disposed between the hand rails. The top section of the ladder above the platform 105 has a right top rail 1 and a left top rail 2. As shown, the right top rail 1 is a continuation of the right hand rail 11, and the left top rail 2 is a continuation of the left hand rail 12. The left and right top rails 1 and 2, instead of being parallel, diverge in the plane of the ladder rails 11, 12 above the scaffold platform. The top rails 1 and 2 are designed to provide the climber with hand holds as the climber ascends the ladder until the climber's feet are at or near the scaffold deck, while the divergence for the top rails 1 and 2 allow the climber to easily pass between the top rails 1 and 2 to gain entry to the scaffold deck 105. Without the divergence, a climber would be forced to swing around the ladder 11 to gain access to the scaffold platform 105, an obviously dangerous maneuver. As shown in FIG. 2A, each top rail diverges, or has an outward bend, providing an additional 1 foot 1 inch of clearance.

Shown in FIG. 2A is a detailed view of one embodiment of a right top rail 1 (a left top rail 2 would, in essence, be a mirror image of a right top rail). The top rail 1 is a pipe having two bent sections. The bottom of the top rail 1 has a flared end 20 for fitting over and attaching to the top of a ladder hand rail, in a male-female interlocking relationship. Obviously, the ladder itself could be made with the top rail incorporated into the hand rail. Other means of joining the top rail to the ladder are available (bolts, brackets, etc).

As shown, the top rail 1 is a pipe section, having two bends, A and B. Obviously, the top rail could be constructed in two or more pieces or sections to accommodate this geometry. Bend A is positioned about 5 inches from the flared end 20 or join with the ladder and is in the plane of the ladder hand rails 11 and 12. The Bend produces the divergence in the right 1 and left top rails 2 away from the ladder hand rails. Bend B (see FIG. 2B) is located at the top of the top rails 1 and 2, and is 90 degrees from the plane of bend A. The purpose of Bend B is to position the top rail 1 for attachment to the scaffold structure 100 through attachment member 30. The scaffold ladder 11 is generally offset from the scaffold structure 100 due to the clamping of the ladder to the structure (one type of clamp is shown in U.S. Pat. No. 6,044,930, incorporated by reference). Since the scaffold ladder 11 is attached to the scaffold structure 100 in a vertical orientation and generally offset from the scaffold structure, the top rails 1 and 2, being a continuation of the hand rails 11 and 12, will require a top section which is offset at 90 degrees to properly position the attachment member 30 for attachment to the scaffold structure 100. For a scaffold ladder attached to the scaffold by the clamp shown in U.S. Pat. No. 6,044,930, a 90 offset of about 9.75 inches is suitable.

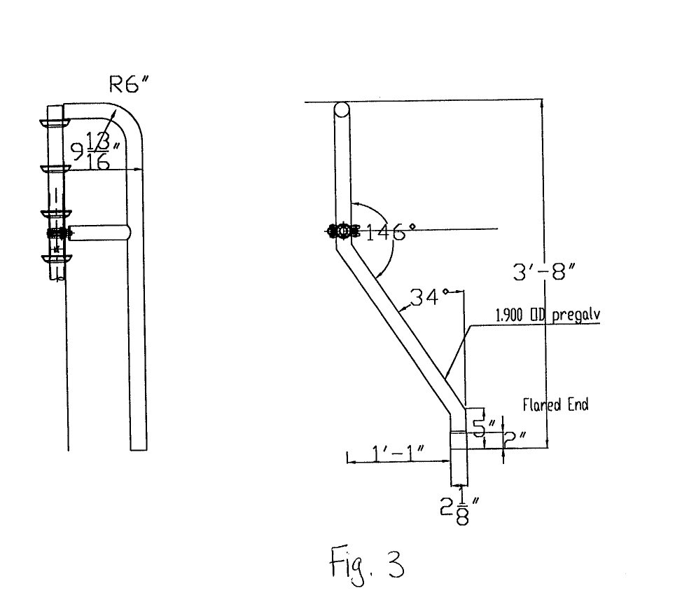

Also shown is attachment member 30, for attaching the top rail 1 or 2 to the scaffold structure 100. The embodiment shown is a hook section with a pivotal latch (not shown) for grasping the cups 103 located on the vertical scaffold members 102. A detailed description of this particular latch is contained in U.S. Pat. Nos. 5,078,532 and 5,028,164 issued to Williams, hereby incorporated by reference. Other types of attachment members 30 could be used. For instance, simply a hooked section for attachment to a scaffold horizontal member 101, or a clamp attachable to either a horizontal or vertical scaffold member (a clamp attachable to a vertical member is shown in FIG. 3), a hook section attachable or engagable to an annular ring or cup positioned on the vertical scaffold member, or alternatively, attached by U-bolts around a vertical or horizontal scaffold member though a plate or flange positioned on the top of the top rail, etc.

Finally, as shown in FIG. 1, is gate 50, attached to the scaffold structure 100 and positioned to open between the top rails. Gate 50 with opens inward toward the scaffold interior and is present to block the opening between the top rails as a safety measure.

Although the present invention has been described in terms of specific embodiments, it is anticipated that alterations and modifications thereof will no doubt become apparent to those skilled in the art which are intended to be included within the scope of the following claims.

We claim:

1. In conjunction with a ladder firmly attachable to a scaffold structure having horizontal and vertical members, the ladder having right and left hand rails and a series of rungs positioned therebetween, said hand rails being substantially parallel, said ladder having a top end and a ground end, a right and left top rail where the right top rail is positioned on said top of said ladder right hand rail, and said left top rail is positioned on said top of said ladder left hand rail, said left and right top rails diverging, each left and right top rail terminating at the diverging ends in an attachment member attachable to a scaffold structure.

2. The right and left top rails according to claim 1 wherein said scaffold structure further has horizontal members and vertical members, and a series of cups on certain of said vertical members, wherein said attachment member is a hook section engagable with a cup positioned on a vertical scaffold member.

3. The right and left top rails according to claim 3 wherein said attachment member further has a pivotable latch member to lock said hook section into a cup on said scaffold.

4. The right and left top rails according to claim 1 wherein said left and said right top rails are removably engagable to said left and right hand rails.

5. The right and left top rails according to claim 1 wherein said left and said right top rails are integral, respectfully, with said left and right hand rails.

6. The right and left top rails according to claim 1 wherein said attachment member comprises a hook section attachable to said scaffold structure.

7. The right and left top rails according to claim 6 wherein said hook section is engagable with said horizontal members of said scaffold structure.

8. Top rails for attaching to a ladder having a top end and a ground end, said ladder further having left and right hand rails, said hand rails being substantially parallel, said top rails comprising a left and right top rail, each said top rail being removably attachable to a ladder near said top end, said top rails diverging when attached to said hand rails.

9. Top rails according to claim 8 wherein said left and right top rails further have an attachment member for attaching to a scaffold structure.

10. Top rails according to claim 9 wherein said attachment member is a hook section.

11. Top rails according to claim 11 where said scaffold vertical members further have cups spaced therealong, and said hook section is engagable with said cups.
